(19) United States
(12) Patent Application Publication
(10) Pub. No.: US 2021/0233070 A1
(43) Pub. Date: Jul. 29, 2021

(54) NOTARY SYSTEM FOR A DISTRIBUTED LEDGER

(71) Applicant: R3 Ltd., London (GB)

(72) Inventor: Tudor Iulian Malene, London (GB)

(21) Appl. No.: 17/160,857

(22) Filed: Jan. 28, 2021

Related U.S. Application Data
(60) Provisional application No. 62/966,991, filed on Jan. 28, 2020.

(51) Int. Cl. G06Q 20/38; G06F 16/23; G06Q 20/02; G06Q 40/04; H04L 9/30; H04L 9/32

(52) U.S. Cl. CPC G06Q 20/3827; G06F 16/2379; G06Q 20/3829; G06Q 20/3825; G06Q 20/389; H04L 2209/38; G06Q 40/04; H04L 9/30; H04L 9/3247; H04L 9/3236; G06Q 2220/00; G06Q 20/02

(57) ABSTRACT

A system is provided for issuing static tokens on a decentralized distributed ledger in which transactions are recorded by parties to the transactions without the use of a blockchain. The system generates an identifier of a token. The system accesses a verification key of the owner of the token. The system generates an issue transaction that outputs the identifier, the verification key, a description of the asset the token represents, and an identification of the issuer. The system adds to the transaction an issuer signature. The system provides the issue transaction to a notary system for notarization. The notary system stores a reference to the output for the token identifier and the verification key. The notary system uses the verification key to determine whether a transfer transaction that inputs the token was signed using the corresponding signing key.

### CROSS-REFERENCE TO RELATED APPLICATION

This application claims priority to U.S. Provisional Patent Application No. 62/966,991 filed Jan. 28, 2020, the content of which is herein incorporated in its entirety.

### BACKGROUND

The bitcoin system was developed to allow electronic cash to be transferred directly from one party to another without going through a financial institution, as described in the white paper entitled “Bitcoin: A Peer-to-Peer Electronic Cash System” by Satoshi Nakamoto. A bitcoin (e.g., an electronic coin) is represented by a chain of transactions that transfers ownership from one party to another party. To transfer ownership of a bitcoin, a new transaction is generated and added to a stack of transactions in a block. The new transaction, which includes the public key of the new owner, is digitally signed by the owner with the owner's private key to transfer ownership to the new owner, as represented by the new owner public key. The signing by the owner of the bitcoin is an authorization by the owner to transfer ownership of the bitcoin to the new owner via the new transaction. Once the block is full, the block is “capped” with a block header, that is, a hash digest of all the transaction identifiers within the block. The block header is recorded as the first transaction in the next block in the chain, creating a mathematical hierarchy called a “blockchain.” To verify the current owner, the blockchain of transactions can be followed to verify each transaction from the first transaction to the last transaction. The new owner need only have the private key that matches the public key of the transaction that transferred the bitcoin. The blockchain creates a mathematical proof of ownership in an entity represented by a security identity (e.g., a public key), which in the case of the bitcoin system is pseudo-anonymous.

To ensure that a previous owner of a bitcoin did not double-spend the bitcoin (i.e., transfer ownership of the same bitcoin to two parties), the bitcoin system maintains a distributed ledger of transactions. The distributed ledger is a blockchain that includes all the transactions for a bitcoin. The blockchain is stored redundantly at multiple nodes (i.e., computers) of a blockchain network. Each node in the blockchain network will store a complete replica of the entire blockchain. The bitcoin system also implements techniques to ensure that each node will store the identical blockchain, even though nodes may receive transactions in different orderings. To verify that the transactions in a ledger stored at a node are correct, the blocks in the blockchain can be accessed from oldest to newest, generating a new hash of the block and comparing the new hash to the hash generated when the block was created. If the hashes are the same, then the transactions in the block are verified. The bitcoin system also implements techniques to ensure that it would be infeasible to change a transaction and regenerate the blockchain by employing a computationally expensive technique to generate a nonce that is added to the block when it is created. A bitcoin ledger is sometimes referred to as an Unspent Transaction Output (“UTXO”) set because it tracks the output of all transactions that have not yet been spent.

Although the bitcoin system has been very successful, it is limited to transactions in bitcoins. Efforts are currently underway to use blockchains to support transactions of any type, such as those relating to the sale of vehicles, sale of financial derivatives, sale of stock, payments on contracts, and so on. Such transactions use tokens to uniquely identify something that can be owned or that can own something. The owner of a token is identified based on the public key of a public/private keypair. When performing a transaction for a token, the owner signs the transaction with its private key (e.g., encrypt a hash of the transaction). The public key can then be used to verify that signature is valid, that is the transaction is signed by the owner.

To record a simple transaction in a blockchain, each party and asset involved with the transaction needs an account that is identified by a digital token. For example, when one person wants to transfer a car to another person, the current owner and next owner create accounts, and the current owner also creates an account that is uniquely identified by the car's vehicle identification number. The account for the car identifies the current owner. The current owner creates a transaction against the account for the car that indicates that the transaction is a transfer of ownership and outputs a token identifying the next owner and a token identifying the car. The transaction is signed by the private key of the current owner, and the transaction is evidence that the next owner is now the current owner.

To enable more complex transactions than bitcoin can support, some systems use “smart contracts.” A smart contract is computer code that implements transactions of a contract. The computer code may be executed in a secure platform (e.g., an Ethereum platform, which provides a virtual machine) that supports recording transactions in blockchains. In addition, the smart contract itself is recorded as a transaction in the blockchain using an token that is a hash of the computer code so that the computer code that is executed can be authenticated. When deployed, a constructor of the smart contract executes, initializing the smart contract and its state. The state of a smart contract is stored persistently in the blockchain. When a transaction is recorded against a smart contract, a message is sent to the smart contract, and the computer code of the smart contract executes to implement the transaction (e.g., debit a certain amount from the balance of an account). The computer code ensures that all the terms of the contract are complied with before the transaction is recorded in the blockchain. For example, a smart contract may support the sale of an asset. The inputs to a smart contract to sell a car may be tokens identifying the seller, the buyer, and the car and the sale price in U.S. dollars. The computer code ensures that the seller is the current owner of the car and that the buyer has sufficient funds in their account. The computer code then records a transaction that transfers the ownership of the car to the buyer and a transaction that transfers the sale price from the buyer's account to the seller's account. If the seller's account is in U.S. dollars and the buyer's account is in Canadian dollars, the computer code may retrieve a currency exchange rate, determine how many Canadian dollars the seller's account should be debited, and record the exchange rate. If either transaction is not successful, neither transaction is recorded.

When a message is sent to a smart contract to record a transaction, the message is sent to each node that maintains a replica of the blockchain. Each node executes the computer code of the smart contract to implement the transaction. For example, if 100 nodes each maintain a replica of a blockchain, then the computer code executes at each of the 100 nodes. When a node completes execution of the computer code, the result of the transaction is recorded in the blockchain. The nodes employ a consensus algorithm to decide which transactions to keep and which transactions to discard. Although the execution of the computer code at each node helps ensure the authenticity of the blockchain, large amounts of computer resources are required to support such redundant execution of computer code.

Although blockchains can effectively store transactions, the large amount of computer resources, such as storage and computational power, needed to maintain all the replicas of the blockchain can be problematic. To overcome this problem, some systems for storing transactions do not use blockchains, but rather have each party to a transaction maintain its own copy of the transaction. One such system is the Corda system developed by R3, Ltd., which provides a decentralized distributed ledger platform in which each participant in the platform has a node (e.g., computer system) that maintains its portion of the distributed ledger. When parties agree on the terms of a transaction, a party submits the transaction to a notary, which is a trusted node, for notarization. The notary maintains a consumed output database of transaction outputs that have been input into other transactions. When a transaction is received, the notary checks the inputs to the transaction against the consumed output database to ensure that the outputs that the inputs reference have not been spent. If the inputs have not been spent, the notary updates the consumed output database to indicate that the referenced outputs have been spent, notarizes the transaction (e.g., by signing the transaction or a transaction identifier with a private key of the notary), and sends the notarized transaction to the party that submitted the transaction for notarization. When the party receives the notarized transaction, the party stores the notarized transaction and provides the notarized transaction to the counterparties.

A distributed ledger system may support identifying a transaction with a hash derived from the content of the transaction. The hash may be the hash of a root node of a Merkle tree for the content. The Merkle tree contains leaf nodes corresponding to hashes of components of the transaction such as a reference that identifies an output of a prior transaction that is input to the transaction, an attachment, and a command. Each non-leaf node contains a hash of the hashes of its child nodes. The Merkle tree may also be considered to have each component as the leaf node with its parent node corresponding to the hash of the component.

A Merkle tree representation of a transaction allows an entity needing access to that transaction to be provided with only that portion that includes the components that the entity needs. For example, if an entity needs only the transaction summary, the entity can be provided with the nodes (and each node's sibling nodes) along the path from the root node to the node of the hash of the transaction summary. The entity can confirm that the transaction summary is that used in the transaction by generating a hash of the transaction summary and calculating the hashes of the nodes along the path to the root node. If the calculated hash of the root node matches the hash of the transaction, the transaction summary is confirmed as the one used in the transaction. Because only the portion of the Merkle tree relating to components that an entity needs is provided, the entity will not have access to other components. Thus, the confidentiality of the other components is not compromised.

A notary may be a non-validating notary or a validating notary. When a non-validating notary is to notarize a transaction, it simply ensures that the prior output of a prior transaction, that is, the input of the transaction, has not been consumed that is an UXTO. If the prior output has not been consumed, the non-validating notary notarizes the transaction by signing a hash of the transaction. To notarize a transaction, a non-validating notary needs only the identification of the prior output (e.g., the hash of the prior transaction and the index of the output) and the portion of the Merkle tree needed to calculate the hash of the transaction.

A validating notary validates the transaction, which may include ensuring that all prior transactions in a backchain of transactions are valid. A backchain is the collection of each prior transaction of the transaction, each prior transaction of those prior transactions, and so on. To validate a transaction, a validating notary invokes validation code of the smart contract of the transaction. The validation code performs whatever checks are needed to comply with the terms applicable to the transaction. This checking may include retrieving the public key of the owner from the prior transaction (pointed to by the input state of the transaction) and checks the signature of the transaction, ensuring that the prior output of a prior transaction that is input has not been consumed, and checking the validity of each transaction in the backchain of the transactions. If the validation code indicates that the transaction is valid, the validating notary notarizes the transaction and records the output of the prior transaction as consumed.

The decision to employ a validating notary or a non-validating notary may take into consideration the advantages and disadvantages of each notary. An advantage of the non-validating notary is that, by not validating prior transactions, the notarization consumes relatively few computational resources and preserves the confidentiality of prior transactions. In addition, the confidentiality of the transaction to be notarized can be preserved because the non-validating notary need only be provided that portion of the Merkle tree that is needed for notarization. A disadvantage is that the transaction may be invalid because some prior transaction in the backchain is invalid or a hidden part of the current transaction is invalid.

Another disadvantage is that a non-validating notary is subject to a “denial of state” attack. A non-validating notary does not ensure that the transaction is authorized by the rightful owner of the prior transaction because it does not check the signature on a transaction using the public key of the owner of the prior transaction. As a result, if a non-validating notary is presented a transaction that is signed by someone other than the owner of the prior transaction, the non-validating notary will notarize the transaction and mark the output of the prior transaction (that is input to the transaction) as having been consumed. The non-validating notary will, however, not know that the transaction is not authorized by the prior owner. When the non-validating notary subsequently receives a transaction that inputs the prior output of the prior transaction and that is signed by the owner of the prior transaction, the non-validating notary will determine that the prior output has already been consumed and refuse to notarize the transaction. In some cases, it may not be possible to change the state of the prior output to not consumed. If possible, the owner of the prior transaction would need to request the non-validating notary to update its records so that the prior output is no longer marked as consumed. As part of this request, the owner of the prior transaction may need to provide evidence of being the owner and of not having signed the unauthorized transaction, which can be an involved and time-consuming process.

A validating notary has the advantage that only valid transactions are notarized. However, the validating notary has the disadvantage of using increasingly more computational resources as the number of prior transactions in a backchain increases. In addition, the prior transactions of the backchain need to be provided by the owner of the transaction to be notarized. When validating a transaction, the validating code may need access to all the components of the transaction. Because both the owner and the validating notary will have access to the entire content of the transaction being notarized and all the prior transactions of the backchain, the confidentiality of those transactions may be compromised.

### BRIEF DESCRIPTION OF THE DRAWINGS

FIG. 1 is a block diagram that illustrates transactions of the notary system in some embodiments.

FIG. 2 is a block diagram that illustrates component of a notary system in some embodiments.

FIG. 3 is a flow diagram that illustrates the processing of the notary system in some embodiments.

### DETAILED DESCRIPTION

Methods and systems are provided for ensuring that a transaction that inputs a token is authorized by the current owner of that token while preserving the privacy of the transaction. The ensuring that a transaction is authorized (e.g., signed by the current owner of the token) helps prevent a denial of state attack. The preserving of privacy helps ensure that information about the token (e.g., value of a currency) cannot be determined solely from the information contained in the transaction. In addition, the validity of a transaction can be ensured without having to walk a backchain of transactions through the use of “static tokens” as described below. An advantage of the methods and systems is that a notary system can determine whether a transaction is authorized and perform some validity checks without reference to a backchain of prior transactions. A non-validating notary system may be augmented to employ these methods and systems and may be considered to be a partial-validating notary system.

In some embodiments, a notary system helps prevent a denial of state attack and helps prevent double spending of a token. Such a notary system may store, for each output of a transaction, token information derived from the output of a transaction. The outputs may include a token identifier and a public key of the new owner. The stored token information may include a reference to the output for the token of the prior transaction and the public key of the new owner. The stored token information represents an output of a transaction that has not yet be spent or consumed. When an issue transaction (that issues a new token) is to be notarized, the notary system stores the reference that identifies the output of the issue transaction for the new token in association with the public key of the owner specified by the issuer. The issue transaction may be represented by a Merkle tree. To notarize an issue transaction, the notary system need only be provided the portion of the Merkle needed to perform the notarization such as the output identifier and the public key of the owner. The notary system does not need to be provided with other information such as a description of the token (e.g., 10 USD).

When the notary system is later requested to notarize a transfer transaction that inputs the token (i.e., the token is being spent), the notary system determines whether that transfer transaction is authorized. The transfer transaction identifies an input by a reference that identifies the prior transaction (e.g., issue or transfer transaction) and the output for the token. The notary system uses that reference to retrieve the public key of the current owner of the token and uses the public key to verify that the transfer transaction is signed by the private key of the current owner and thus authorized. The transfer transaction outputs the token and a public key of the new owner, the notary system stores a reference to the output for the token in association with the public key of the new owner for use in ensuring that a subsequent transaction that inputs the token is authorized by new owner and has not yet been consumed. The notary system then signs the transfer transaction and designates the output of the prior transaction as consumed. In this way, the notary system can help prevent a denial of state attack by refusing to notarize transfer transactions that are not signed by the current owner of the token and helps prevent the double spending of a token.

In some embodiments, the keys used to sign transactions may be composite keys. A composite key includes multiple public keys and identifies what combinations of those public keys are needed to sign a transaction. For example, a composite key may include the public keys of a president and two vice presidents of a company. The composite key may specify that a valid signature on a transfer transaction can be (1) just the signature of the president or (2) the combination of the signatures the vice presidents. A party can use the composite key to ensure that (1) or (2) is satisfied. (See, U.S. Patent Pub No. 20200302409, entitled “Composite Keys for Authorization Policies,” assigned to R3 Ltd., and published on Sep. 24, 2020, which is hereby incorporated by reference.) A transaction may also output computer code that can be executed to determine whether a subsequent transfer transaction that inputs a token output by the transaction is authorized. When the transfer transaction is to be notarized, the notary system executes the computer code to determine if the transfer transaction is authorized. The computer code may place virtually any requirement for authorization such as requiring a stock price above a certain level, the transfer date to be before an expiration date, a certain sum to have been deposited in a bank account, and so on.

A public key, a composite key, or computer code may be considered to be “authorization mechanisms.” An “authorization identifier” identifies and may be a hash of an authorization mechanism such as a hash of computer code. A transaction may output an authorization identifier of the authorization mechanism (rather than the authorization mechanism itself) to be used to valid a subsequent transaction. In such as case, a notary system stores the authorization identifier rather than the authorization mechanism. When a transfer transaction is submitted to the notary system, the submitter also provides the authorization mechanism. Assuming that the authorization identifier is a hash, the notary system can verify that the hash of the authorization mechanism matches the hash stored in association with the output that is an input to the transfer transaction. If the hashes match, the notary system verifies the transaction is authorized using the authorization mechanism. The authorization mechanisms may also be stored in a repository that is made accessible to the notary system. The notary can retrieve the authorization mechanism that matches the hash that it stores. The authorization mechanism may be encrypted using a public key of the notary system. The authorization mechanisms and an authorization identifier may be considered to be “authorization information.”

Although the notary system is described primarily in the context of signing transactions based on private and public keys, the signing may be performed more generally based on signing and verification keys. A private and public keypair is an example of signing and verification keys. In addition, although the notary system is described primarily as using a public key, the notary system can use a composite key or computer code in place of a public key or more generally authorization information.

In some embodiments, to help ensure the privacy of a transaction, the transactions may issue or transfer “static” tokens. A static token does not change while owned or when transferred to a new owner. A static token is thus in some ways similar to a physical coin or paper currency. Like a physical coin or paper currency, a static token cannot be divided into multiple tokens and cannot be combined with another token into an aggregate token. For example, a static token that is issued with a token value of $20 cannot be input to a transfer transaction that divides the static token into two output tokens with a token value of $10 each. This is analogous to a $20 bill that cannot be physically cut in half to form two $10 bills. Also, if a transfer transaction that inputs two static tokens with a token value of $10 each, the transfer transaction cannot combine the static tokens and output a token with a token value of $20. This is analogous to a $10 bill that cannot be glued to another $10 bill to make a $20 bill. Thus, a transfer transaction that inputs a static token can only output that static token (or retire the static token by not outputting the static token). A static token is thus indivisible and uncombinable.

Although static tokens are indivisible and uncombinable, static tokens of different token values (i.e., different denominations) can be used to support transfer transactions involving values that do not correspond to a discrete token value. For example, a bank may issue static tokens having token values of $10, $5, and $1. A buyer who owns a $10 token may want to pay $3 to another seller who owns a $5 token and two $1 tokens. In such a case, the transfer transaction may input the $10 token, the $5 token, and the two $1 tokens and transfer the $10 token to the seller and the $5 token and the two $1 tokens to the buyer. Although the transfer transactions are described primarily as inputting static tokens, they can also input and output non-static tokens. For example, a transfer transaction in which an insurance company pays a policyholder for a claim against an insurance policy may input a non-static token that identifies the claim and a static token that represents the payment and outputs the non-static token, the static token, and a public key of the policyholder.

Each static token is identified by a unique token identifier. The issuer of a static token creates an issue transaction that outputs the token value of the static token (e.g., amount of a currency or precious metal), a token identifier, and an identifier of the issuer (and may also output the public key of the owner of the token). The token identifier may be a randomly selected number (e.g., 128 bits) that uniquely identifies the static token to a very high probability. The issuer then requests the notary system to notarize the issue transaction. The notary system may also check that the issue transaction is signed using the private key of the issuer and that the token identifier was not used in a prior issue transaction notarized by the notary system. The notary system stores the token identifier and the reference to the output of the token but need not store the token value or the issuer. The notary system may store the token identifier in association with the reference to the output for the token.

A transfer transaction that transfers a static token inputs a reference to the output of a prior transaction that outputs that static token. The transfer transaction, however, does not need to input the token value or the identifier of the issuer that are output by the issue transaction. Since neither need be input to a transfer transaction, an entity that gains access to a transfer transaction cannot determine the token value or identity of the issuer without also having access to the issue transaction.

When the owner of a static token is to transfer a static token, the owner may present the proposed transfer transaction along with the prior transaction involving the static token to the new owner. The new owner is provided with the issue transaction and can thus determine the token value and the identity of the issuer from the issue transaction, which has been notarized. The new owner can then have the transfer transaction notarized and store both the issue transaction and the transfer transaction. That new owner can provide the issue transaction to a subsequent owner for verifying the token value. In this way, an entity that has access to just the transfer transaction cannot determine the token value (or even what the static token represents such as a quantity of petroleum or a bond) or the identity of the issuer.

In some embodiments, a notary system (e.g., that is a non-validating notary as described above) may perform various “validity” checks. For example, the notary system may check each transfer transaction whose output is input to a transfer transaction to ensure that the inputs (e.g., a non-static tokens) are notarized. As another example, the notary system may also check to ensure a static token is only output once by a transaction. For example, the notary system may ensure that an issue transaction does not output a static token multiple times.

In some embodiments, the notary system may store only the token identifier of a static token (rather than a reference to the output of a transaction) in association with the public key to track outputs that have not been consumed (or outputs that have been consumed). In such a case, a transfer transaction need only input the token identifier (and not the reference to the output of the prior transaction). The notary system can retrieve the public key associated with the token identifier and verify that the transfer transaction is authorized. The notary system then stores the public key of the new owner in place of the public key of the prior owner. A token identifier of a token and a reference to an output of a transaction for a token may be characterized more generally as “token designators.”

In some embodiments, the notary system may include an authorization component and/or a static token component. The authorization component controls the storing of the public keys of owners (i.e., authorization mechanisms) of the outputs of transactions to help prevent a denial of state attack. The authorization component stores the public keys in an unspent output table (e.g., the unspent token table). The static token component verifies that an input that is a static token is output as the same static token or retired.

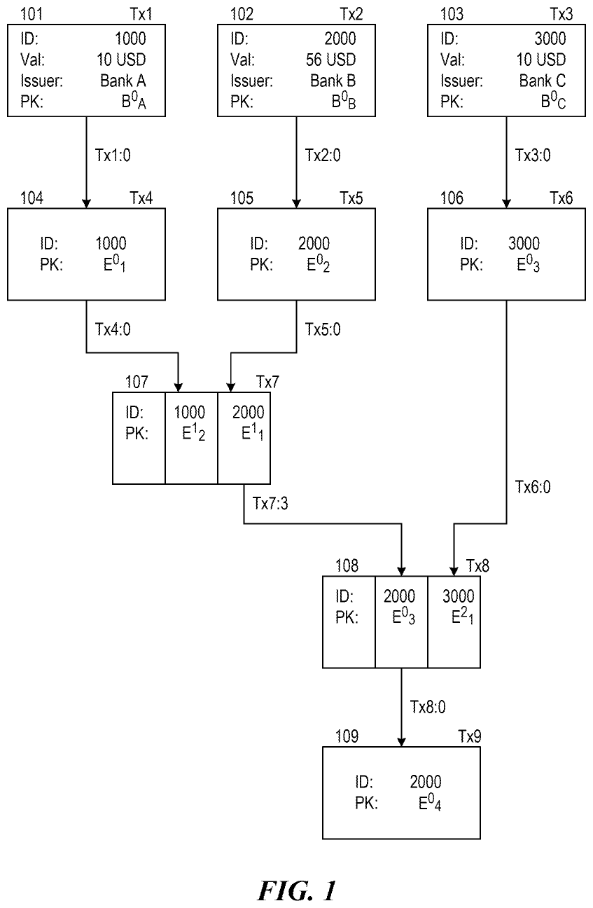

FIG. 1 is a block diagram that illustrates transactions of the notary system in some embodiments. Transactions Tx1-Tx3 (101-103) are issue transactions that issue static tokens. Each issue transaction outputs a token identifier (ID), a token value (Val), an identifier of the issuer, and the public key of the owner. (The outputs of a transaction are represented by the content of the blocks.) For example, Tx1 represents Bank A issuing a static token to itself as the owner represented by a public key B⁰_{A} of Bank A. (The superscript identifies a public key of Bank A.) The static token has a token identifier of 1000 and a token value of 10 USD. Tx2 and Tx3 similarly represent banks issuing static tokens to themselves. Transactions Tx4-Tx6 (104-106) represent the transfer of static tokens output by Tx1-Tx3 from Banks A, B, and C to new owners represented by public keys E⁰₁, E⁰₂, and E⁰₃ for entities 1, 2, and 3. The “Tx1:0” by the line between Tx1 and Tx4 represents that Tx4 inputs output 0 of Tx1. Output 0 of transaction Tx1 is the token identifier. Tx4-Tx6 do not include the token value or an identification of the issuer to help preserve privacy. Tx4-Tx6 output the input token identifier and a public key of a new owner. Transaction Tx7 (107) inputs Tx4:0 and Tx5:0 representing static tokens 1000 and 2000. Tx7 outputs static tokens 1000 and 2000. Tx7 represents that entity 1 and entity 2 exchanged static tokens with token values of 10 USD and 5 GBP. Transaction Tx8 (108) inputs Tx7:3 and Tx6:0 that is static tokens 2000 and 3000 and outputs the static tokens. Even though static tokens 2000 and 3000 each has a value in USD, the static tokens cannot be divided into new static tokens or combined into a single static token. Transaction Tx9 (109) inputs Tx8.0 that is a static token 2000 and outputs static token 2000. If Tx9 did not output static token 2000, then static token 2000 would be retired presumably by the issuer Bank B. The static tokens 1000, 2000, and 3000 output by Tx7, Tx9, and Tx8, respectively, are not consumed and thus available as inputs to other transactions.

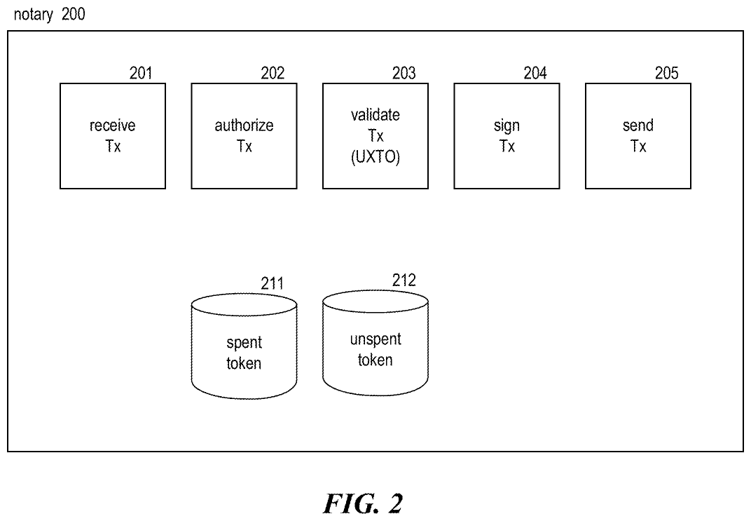

FIG. 2 is a block diagram that illustrates components of a notary system in some embodiments. A notary system 200 includes a received transaction component 201, an authorize transaction component 202, a validate transaction component 203, a sign transaction component 204, and a send transaction component 205. The notary system also includes a spent token data store 211 and an unspent token data store 212. The receive transaction component receives from a requesting entity a transaction that is to be notarized, and the send transaction component sends to the requesting entity the notarized transaction. The spent token data store may store information on output that has been spent specified by a token designator such as a reference to that output or a token identifier. The information can be used to determine whether an output has already been spent. The unspent token data store information on tokens that have not been spent as described below.

The authorize transaction component determines whether a signature on a transaction is valid that is signed by the entity authorized to sign that transaction. For an issue transaction, the authorize transaction component may retrieve the public key of the issuer (e.g., from a certificate authority) and verify that the signature using the public key. (Alternatively, a new owner may be responsible for verifying the signature of the issuer). The authorize transaction component also store in the unspent token data store a reference to the output (e.g., the static token) in association with the public key of the owner of the output. For a transfer transaction, the authorize transaction component retrieves from the unspent token data store the public key associated with the reference that is input to the transfer transaction. If the reference is not in the unspent token data store, then the transfer transaction is considered to be invalid. The transfer transaction is invalid because there may not have an issue transaction with such an output state reference, or the output was already spent by another transaction. If the reference is in the unspent transaction data store, the authorize transaction component uses the public key associated with the reference to verify the signature of the transfer transaction which indicates the transfer transaction is authorized. If not authorized, the authorize transaction component does not notarize the transfer transaction. If authorized (and assuming it is valid if validation is performed), the authorize transaction component updates the unspent transaction data store to remove the reference and associated public key and adds a reference to the output of the transfer transaction and the public key of the new owner that is output by the transfer transaction. The authorized transaction component the signs the transfer transaction with the public key of the notary system.

The validate transaction component may perform conventional validations (e.g., on non-static tokens) and further static token validations. One static token validation is to ensure that a token identifier that is output by the transfer transaction was input by was output by the prior transaction identified by reference that is input of the transfer transaction. This validation ensures that a transfer transaction does not “issue” a new static token because static tokens are issued by issue transactions. To support this validation, the notary may also store in the unspent token data store the token identifier in association with a reference to the output for the token identifier when a static token is issued. To validate a transfer transaction, the validate transaction component retrieves from the unspent transaction store the token identifier associated with a reference that is input and may check whether that the transfer transaction inputs that token identifier only once. If the token identifier is output (only once), the validate transaction component removes the association between the token identifier and the reference to the output of the prior transaction and adds an association between the token identifier and the reference to the output of the transfer transaction. If valid (and assuming it is authorized if authorization is performed), the validate transaction component signs the transfer transaction with the public key of the notary system.

The computing systems (e.g., nodes) on which the notary system may be implemented may include a central processing unit, input devices, output devices (e.g., display devices and speakers), storage devices (e.g., memory and disk drives), network interfaces, graphics processing units, cellular radio link interfaces, global positioning system devices, and so on. The input devices may include keyboards, pointing devices, touch screens, gesture recognition devices (e.g., for air gestures), head and eye tracking devices, microphones for voice recognition, and so on. The computing systems may include desktop computers, laptops, tablets, e-readers, personal digital assistants, smartphones, gaming devices, servers, and so on. The computing systems may access computer-readable media that include computer-readable storage media and data transmission media. The computer-readable storage media are tangible storage means that do not include a transitory, propagating signal. Examples of computer-readable storage media include memory such as primary memory, cache memory, and secondary memory (e.g., DVD) and other storage. The computer-readable storage media may have recorded on it or may be encoded with computer-executable instructions or logic that implements the notary system. The data transmission media is used for transmitting data via transitory, propagating signals or carrier waves (e.g., electromagnetism) via a wired or wireless connection. The computing systems may include a secure cryptoprocessor as part of a central processing unit for generating and securely storing keys and for encrypting and decrypting data using the keys.

The notary system may be described in the general context of computer-executable instructions, such as program modules and components, executed by one or more computers, processors, or other devices. Generally, program modules or components include routines, programs, objects, data structures, and so on that perform particular tasks or implement particular data types. Typically, the functionality of the program modules may be combined or distributed as desired in various examples. Aspects of the notary system may be implemented in hardware using, for example, an application-specific integrated circuit (“ASIC”) or field programmable gate array (“FPGA”).

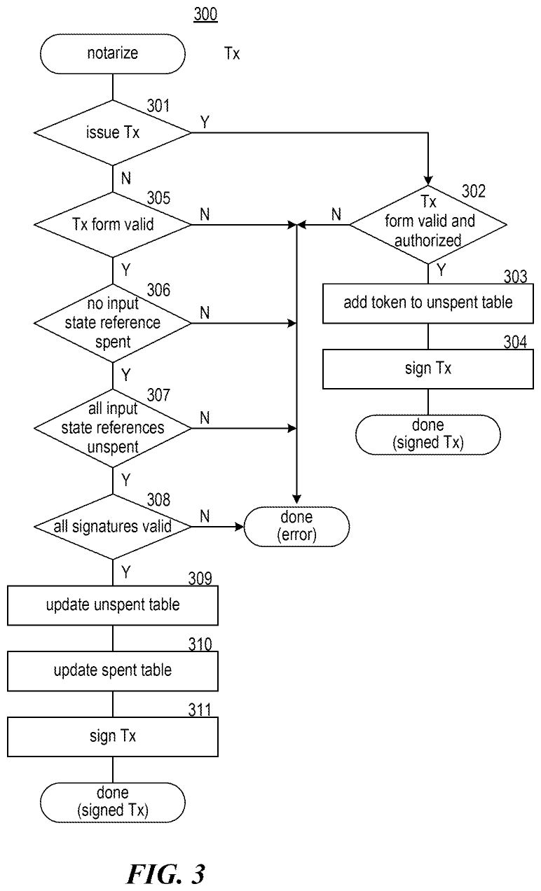

FIG. 3 is a flow diagram that illustrates the processing of the notary system in some embodiments. The notary system is provided a transaction for a static token that is to be notarized. In decision block 301, if the transaction is an issue transaction, then the system continues at block 302, else the transaction is a transfer transaction, and the system continues at block 305. In decision block 302, if the form of the transaction is valid and the transaction is authorized (i.e. signed by the issuer), then the system continues at block 303, else the system completes indicating an error. The system may also ensure that the token identifier is unique and not already in the unspent token data store. In block 303, the system adds the token identifier and associated reference to the unspent token data store. In block 304, the system signs the transaction and completes. In decision block 305, if the form of the transaction is valid (e.g., no static tokens are being issued), then the system continues at block 306, else the system completes indicating an error. In decision block 306, if no reference that is input is indicated as having been spent, then the system continues at block 307, else the system completes indicating an error. In decision block 307, if all the references for static tokens that are input are in the unspent token data store, then the system continues at block 308, else the system completes indicating error. In decision block 308, if all the signatures are valid based on the public keys stored in the unspent token data store, then the system continues at block 309, else the system completes indicating an error. In block 309, the system updates the unspent token data store to remove the prior association for the token identifier and add a new association between the token identifier and the reference to the output for the token identifier of the transaction. In block 310, the system updates the spent token data store to indicate that the reference that is input by the transaction has been spent. In block 311, the system signs the transaction and completes.

The following paragraphs describe various embodiments of aspects of the notary system. An implementation of the notary system may employ any combination of the embodiments. The processing of the methods described below may be performed by a computing device with a processor that executes computer-executable instructions stored on a computer-readable storage medium that implements the notary system.

A method performed by one or more computing systems is provided for determining whether a transfer transaction is authorized. The method accesses an input of the transfer transaction. The input is a reference identifying an output of a prior transaction. The output identifies an asset that has a current owner. The method accesses a public key associated with the input reference. The public key is a public key of the current owner. The method determines, using the public key associated with the reference identifying the output of the prior transaction, whether a signature for the transfer transaction corresponds to the signature of the current owner. After determining that the signature corresponds to the signature of the current owner, the method accessing a public key output by the transfer transaction, the public key output by the transaction being a public key of a new owner of the asset and identified by an output of the transfer transaction and stores he public key output by the transfer transaction in association with a reference identifying an output of the transfer transaction. In some embodiments, the method, after determining that the signature corresponds to the signature of the current owner, notarizes the transfer transaction. In some embodiments, the method further determines whether the transfer transaction outputs a static token that is not input to the transfer transaction and upon determining that the static token is not input to the transfer transaction, indicating that the transfer transaction is not valid. In some embodiments, the method further determines whether the transfer transaction inputs a static token multiple times, and upon determining that the static token is output multiple times, indicates that the transfer transaction is not valid. In some embodiments, the method further determines whether the transfer transaction outputs a static token that is not input to the transfer transaction, and upon determining that transfer transaction outputs a static token that is not input to the transfer transaction, indicates that the transfer transaction is not valid. In some embodiments, an input to the transfer transaction is a token identifier of a static token and the designated output is the token identifier. In some embodiments, the method stores the token identifier in association with the reference identifying the output of the transfer transaction. In some embodiments, the method accesses an issue transaction that outputs a token identifying the asset and outputs an initial public key of an initial owner of the token and stores the initial public key in association with an initial state reference identifying an output of the issue transaction. In some embodiments, the method, after determining that the signature corresponds to the signature of the current owner, indicates that the transfer transaction is authorized. In some embodiments, the method indicates that the output of the prior transaction has been consumed. In some embodiments, the method accesses a data store to determine whether the output of prior transaction has been consumed wherein the public key of the new owner is stored when both the output of the prior transaction has not been consumed and the signature corresponds to the signature of the current owner.

In some embodiments, a method performed by one or more computing systems is provided for issuing tokens for an asset. The method generates a token identifier of a token representing the asset. The asset has an owner. The method accesses authorization information of the owner. The method generates an issue transaction that outputs: the token identifier, the authorization information, a description of the asset, and an identification of an issuer of the token. Th method adds to the issue transaction an issuer signature generated by the issuer and provides the issue transaction to a notary system for notarization. In some embodiments, the method under control of the notary system, accesses at least a portion of the issue transaction; stores an indication of the authorization information, the token identifier, and a reference to the output of the issue transaction for the token identifier; and notarizes the issue transaction. The method, under control of the notary system, accesses a transfer transaction that inputs the reference to the output of the issue transaction for the token identifier; accesses the authorization information associated with the reference to the output of the issue transaction for the token identifier; determines using the authorization information, whether the transfer transaction is authorized; and notarizes the transfer transaction. In some embodiments, the method, under control of the notary system, stores an indication of authorized information output by the transfer transaction and a reference to the output of the transfer transaction for the token identifier. In some embodiments, the method, under control of the notary system, stores an indication of authorization information output by the transfer transaction and the token identifier. In some embodiments, the authorization information is an authorization mechanism. In some embodiments, the authorization information is an authorization identifier of an authorization mechanism.

In some embodiments, a method performed by one or more computing systems is provided for notarizing a transaction. The method accesses a transaction that outputs authorization information and a token, stores the authorization information in association with token designator for use in determining whether a subsequent transfer transaction for transferring the token is authorized; and notarizes the transaction. In some embodiments, the token designator is a token identifier assigned by an issuer of the token. In some embodiments, the token designator is a reference to an output of the transaction that outputs the token. In some embodiments, the authorization information is an authorization mechanism. In some embodiments, the authorization mechanism is computer code. In some embodiments, the authorization information is an authorization identifier of an authorization mechanism. In some embodiments, the authorization information is a hash of the authorization mechanism. In some embodiments, the method accesses a transfer transaction that inputs the token designator, accesses the authorization information that is stored in association with the token designator, determines, using the authorization information, whether transfer transaction is authorized, and notarizes the transfer transaction. In some embodiments, the transaction is a transfer transaction, the token is a static token, and the transfer transaction outputs a token identifier of the static token. In some embodiments, the method validates that the token identifier is only output once. In some embodiments, the method validates that the transfer transaction inputs the token. In some embodiments, the method validates that the transfer transaction inputs the token only once.

In some embodiments, a performed by one or more computing systems is provided for generating a transfer transaction. The method accesses a token identifier of a static token that is output by a prior transaction. The static token is owned by a current owner). The method accesses authorization information of a new owner of the token. The method adds as an input to the transfer transaction a token designator for the static token that is output by the prior transaction. The method adds as an output to the transfer transaction the token identifier. The method adds as an output to the transfer the authorization information of the new owner. In some embodiments, the method submits the transfer transaction to a notary system. In some embodiments, the method submits authorization information of the current owner to the notary system. In some embodiments, the method receives an issue transaction for the token and verifying that issue transaction is notarized and outputs the token identifier. In some embodiments, the method verifies that the issue transaction outputs an identifier of an issuer of the static token and outputs a description of an asset that the token represents. In some embodiments, the token designator is the token identifier assigned by an issuer of the token. In some embodiments, the token designator is a reference to an output of the transaction that outputs the token. In some embodiments, the authorization information is an authorization mechanism. In some embodiments, the authorization mechanism is selected from a group consisting of a public key, a composite key and computer code. In some embodiments, the authorization information is an authorization identifier of an authorization mechanism. In some embodiments, authorization identifier is a hash of the authorization mechanism.

In some embodiments, one or more computing systems is provided for notarizing a transaction. The one or more computing systems includes one or more computer-readable storage mediums for storing computer-executable instructions for controlling the one or more computing systems and one or more processors for executing the computer-executable instructions stored in the one or more computer-readable storage mediums. The instructions control the one or more computing system to access a transaction that outputs authorization information and outputs data, the authorization information for determining whether a transfer of the data is authorized, store the authorization information in association with a data designator that identifies the data for use in determining whether a subsequent transfer transaction for transferring the data is authorized without having to access the transaction, and notarize the transaction. In some embodiments, the data represents a static token that is output by a prior transaction and the data designator is a token identifier output by the issue transaction that issued the static token. In some embodiments, wherein the data is output by a prior transaction and the data designator is reference to a prior transaction and an output of the prior transaction. In some embodiments, the authorization information is an authorization mechanism. In some embodiments, the authorization mechanism is computer code. In some embodiments, the authorization information is an authorization identifier of an authorization mechanism. In some embodiments, the authorization information is a hash of the authorization mechanism. In some embodiments, the instructions further control the one or more computing system to access a transfer transaction that inputs the data designator, access the authorization information that is stored in association with the data designator, determine, using the authorization information, whether transfer transaction is authorized, and notarize the transfer transaction. In some embodiments, wherein the transaction is a transfer transaction, the data is a static token, and the transfer transaction outputs a token identifier of the static token.

In some embodiments, one or more computer-readable storage mediums are provided that store a transaction, the one or more computer-readable storage mediums comprising a data structure that includes a first input that inputs a token designator of a static token that is output by a prior transaction, the static token being owned by a current owner, that includes a first output that outputs the token designator, that includes a second output that outputs authorization information of a next owner of the token wherein the transaction inputs the token designator only once and outputs the token designator only once. In some embodiments, the transaction is signed by the current owner of the static token. In some embodiments, the transaction is signed by a notary system.

In some embodiments, one or more computing systems are provided for coordinating notarization of a transfer transaction. The one or more computing systems comprising one or more computer-readable storage mediums for storing computer-executable instructions for controlling the one or more computing systems and one or more processors for executing the computer-executable instructions stored in the one or more computer-readable storage mediums. Under control of a first system, the instructions access a transfer transaction that inputs a token identifier of a static token that is owned by a current owner, outputs authorization information of a new owner of the static token, and outputs the token identifier. The instructions send to a notary system the transfer transaction and receive from the notary system the notarized transfer transaction. Under control of the notary system, the instructions receive from the first system the transfer transaction, determine whether the transfer transaction is authorized using prior authorization information stored by the notary system when a prior transaction that output the token identifier was notarized, store the authorization information of the transfer transaction and a token designator of the static token, notarize the transfer transaction, and send to the first system the notarized transaction.

Although the subject matter has been described in language specific to structural features and/or acts, it is to be understood that the subject matter defined in the appended claims is not necessarily limited to the specific features or acts described above. Rather, the specific features and acts described above are disclosed as example forms of implementing the claims. Accordingly, the invention is not limited except as by the appended claims.

1. A method performed by one or more computing systems for determining whether a transfer transaction is authorized, the method comprising:
accessing an input of the transfer transaction, the input being a reference identifying an output of a prior transaction, the output identifying an asset that has a current owner;
accessing a public key associated with the input reference, the public key being a public key of the current owner;
determining, using the public key associated with the reference identifying the output of the prior transaction, whether a signature for the transfer transaction corresponds to the signature of the current owner; and
after determining that the signature corresponds to the signature of the current owner,
accessing a public key output by the transfer transaction, the public key output by the transaction being a public key of a new owner of the asset and identified by an output of the transfer transaction; and
storing the public key output by the transfer transaction in association with a reference identifying an output of the transfer transaction.

2. The method of claim 1 further comprising, after determining that the signature corresponds to the signature of the current owner, notarizing the transfer transaction.

3. The method of claim 1 further comprising determining whether the transfer transaction outputs a static token that is not input to the transfer transaction and upon determining that the static token is not input to the transfer transaction, indicating that the transfer transaction is not valid.

4. The method of claim 1 further comprising determining whether the transfer transaction inputs a static token multiple times, and upon determining that the static token is output multiple times, indicating that the transfer transaction is not valid.

5. The method of claim 1 further comprising determining whether the transfer transaction outputs a static token that is not input to the transfer transaction, and upon determining that transfer transaction outputs a static token that is not input to the transfer transaction, indicating that the transfer transaction is not valid.

6. The method of claim 1 wherein an input to the transfer transaction is a token identifier of a static token and the designated output is the token identifier.

7. The method of claim 6 further comprising storing the token identifier in association with the reference identifying the output of the transfer transaction.

8. The method of claim 1 further comprising:
accessing an issue transaction that outputs a token identifying the asset and outputs an initial public key of an initial owner of the token; and
storing the initial public key in association with an initial state reference identifying an output of the issue transaction.

9. The method of claim 1 further comprising after determining that the signature corresponds to the signature of the current owner, indicating that the transfer transaction is authorized.

10. The method of claim 1 further comprising indicating that the output of the prior transaction has been consumed.

11. The method of claim 1 further comprising accessing a data store to determine whether the output of prior transaction has been consumed wherein the public key of the new owner is stored when both the output of the prior transaction has not been consumed and the signature corresponds to the signature of the current owner.

12. A method performed by one or more computing systems for issuing tokens for an asset, the method comprising:
generating a token identifier of a token representing the asset, the asset having an owner;
accessing authorization information of the owner;
generating an issue transaction that outputs:
the token identifier;
the authorization information;
a description of the asset; and
an identification of an issuer of the token;
adding to the issue transaction an issuer signature generated by the issuer; and
providing the issue transaction to a notary system for notarization.

13. The method of claim 12 further comprising, under control of the notary system:
accessing at least a portion of the issue transaction;
storing an indication of the authorization information, the token identifier, and a reference to the output of the issue transaction for the token identifier; and
notarizing the issue transaction.

14. The method of claim 13 further comprising, under control of the notary system:
accessing a transfer transaction that inputs the reference to the output of the issue transaction for the token identifier;
accessing the authorization information associated with the reference to the output of the issue transaction for the token identifier;
determining, using the authorization information, whether the transfer transaction is authorized; and
notarizing the transfer transaction.

15. The method of claim 13 further comprising, under control of the notary system, storing an indication of authorized information output by the transfer transaction and a reference to the output of the transfer transaction for the token identifier.

16. The method of claim 13 further comprising, under control of the notary system, storing an indication of authorization information output by the transfer transaction and the token identifier.

17. The method of claim 13 wherein the authorization information is an authorization mechanism.

18. The method of claim 13 wherein the authorization information is an authorization identifier of an authorization mechanism.

19. A method performed by one or more computing systems for notarizing a transaction, the method comprising:
accessing a transaction that outputs authorization information and a token;
storing the authorization information in association with token designator for use in determining whether a subsequent transfer transaction for transferring the token is authorized; and
notarizing the transaction.

20. The method of claim 19 wherein the token designator is a token identifier assigned by an issuer of the token.

21. The method of claim 19 wherein the token designator is a reference to an output of the transaction that outputs the token.

22. The method of claim 19 wherein the authorization information is an authorization mechanism.

23. The method of claim 22 wherein the authorization mechanism is computer code.

24. The method of claim 19 wherein the authorization information is an authorization identifier of an authorization mechanism.

25. The method of claim 24 wherein the authorization information is a hash of the authorization mechanism.

26. The method of claim 19 further comprising:
accessing a transfer transaction that inputs the token designator;
accessing the authorization information that is stored in association with the token designator;
determining, using the authorization information, whether transfer transaction is authorized; and
notarizing the transfer transaction.

27. The method of claim 19 wherein the transaction is a transfer transaction, the token is a static token, and the transfer transaction outputs a token identifier of the static token.

28. The method of claim 27 further comprising validating that the token identifier is only output once.

29. The method of claim 27 further comprising validating that the transfer transaction inputs the token.

30. The method of claim 27 further comprising validating that the transfer transaction inputs the token only once.

31. A method performed by one or more computing systems for generating a transfer transaction, the method comprising:
access a token identifier of a static token that is output by a prior transaction, the static token being owned by a current owner;
accessing authorization information of a new owner of the token;
adding as an input to the transfer transaction a token designator for the static token that is output by the prior transaction;
adding as an output to the transfer transaction the token identifier; and
adding as an output to the transfer the authorization information of the new owner.

32. The method of claim 31 further comprising submitting the transfer transaction to a notary system.

33. The method of claim 32 further comprising submitting authorization information of the current owner to the notary system.

34. The method of claim 31 further comprising receiving an issue transaction for the token and verifying that issue transaction is notarized and outputs the token identifier.

35. The method of claim 34 further comprising verifying that the issue transaction outputs an identifier of an issuer of the static token and outputs a description of an asset that the token represents.

36. The method of claim 31 wherein the token designator is the token identifier assigned by an issuer of the token.

37. The method of claim 31 wherein the token designator is a reference to an output of the transaction that outputs the token.

38. The method of claim 31 wherein the authorization information is an authorization mechanism.

39. The method of claim 38 wherein the authorization mechanism is selected from a group consisting of a public key, a composite key and computer code.

40. The method of claim 38 wherein the authorization information is an authorization identifier of an authorization mechanism.

41. The method of claim 38 wherein the authorization identifier is a hash of the authorization mechanism.

42. One or more computing systems for notarizing a transaction, the one or more computing systems comprising:
one or more computer-readable storage mediums for storing computer-executable instructions for controlling the one or more computing systems to:
access a transaction that outputs authorization information and outputs data, the authorization information for determining whether a transfer of the data is authorized;
store the authorization information in association with a data designator that identifies the data for use in determining whether a subsequent transfer transaction for transferring the data is authorized without having to access the transaction; and
notarize the transaction; and
one or more processors for executing the computer-executable instructions stored in the one or more computer-readable storage mediums.

43. The one or more computing systems of claim 42 wherein the data represents a static token that is output by a prior transaction and the data designator is a token identifier output by the issue transaction that issued the static token.

44. The one or more computing systems of claim 42 wherein the data is output by a prior transaction and the data designator is reference to a prior transaction and an output of the prior transaction.

45. The one or more computing systems of claim 42 wherein the authorization information is an authorization mechanism.

46. The one or more computing systems of claim 42 wherein the authorization mechanism is computer code.

47. The one or more computing systems of claim 42 wherein the authorization information is an authorization identifier of an authorization mechanism.

48. The one or more computing systems of claim 47 wherein the authorization information is a hash of the authorization mechanism.

49. The one or more computing systems of claim 42 wherein the instructions further control the one or more computing system to:
access a transfer transaction that inputs the data designator;
access the authorization information that is stored in association with the data designator;
determine, using the authorization information, whether transfer transaction is authorized; and
notarize the transfer transaction.

50. The one or more computing systems of claim 42 wherein the transaction is a transfer transaction, the data is a static token, and the transfer transaction outputs a token identifier of the static token.

51. One or more computer-readable storage mediums that store a transaction, the one or more computer-readable storage mediums comprising:
a data structure that includes:
a first input that inputs a token designator of a static token that is output by a prior transaction, the static token being owned by a current owner;
a first output that outputs the token designator;
a second output that outputs authorization information of a next owner of the token
wherein the transaction inputs the token designator only once and outputs the token designator only once.

52. The one or more computer-readable storage mediums of claim 51 wherein the transaction is signed by the current owner of the static token.

53. The one or more computer-readable storage mediums of claim 52 wherein the transaction is signed by a notary system.

54. One or more computing systems coordinate notarization of a transfer transaction, the one or more computing systems comprising:
one or more computer-readable storage mediums for storing computer-executable instructions for controlling the one or more computing systems to:
under control of a first system:
access a transfer transaction that:
inputs a token identifier of a static token that is owned by a current owner;
outputs authorization information of a new owner of the static token; and
outputs the token identifier;
send to a notary system the transfer transaction; and
receive from the notary system the notarized transfer transaction; and
under control of the notary system,
receive from the first system the transfer transaction;
determine whether the transfer transaction is authorized using prior authorization information stored by the notary system when a prior transaction that output the token identifier was notarized;
store the authorization information of the transfer transaction and a token designator of the static token;
notarize the transfer transaction; and
send to the first system the notarized transaction; and
one or more processors for executing the computer-executable instructions stored in the one or more computer-readable storage mediums.
